(19) United States
(12) Patent Application Publication
(10) Pub. No.: US 2013/0275516 A1
(43) Pub. Date: Oct. 17, 2013

(54) Avoiding Communication at Designated No-Contact Times

(71) Applicant: Scott A. Grant, Sunnyvale, CA (US)

(72) Inventor: Scott A. Grant, Sunnyvale, CA (US)

(73) Assignee: APPLE INC., Cupertino, CA (US)

(21) Appl. No.: 13/444,455

(22) Filed: Apr. 11, 2012

(51) Int. Cl. G06F 15/173; G06F 15/16

(52) U.S. Cl. 709/206; 709/223

(57) ABSTRACT

Apparatus and methods for controlling communications allow a recipient of electronic communications to be designated as in a no-contact state based on a profile data associated with the recipient. An attempt to send an electronic communication to the recipient when the recipient is in a no-contact state will result in the electronic communication not being transmitted at that time, although variants may allow queuing the electronic communication for later delivery. The no-contact state based on the profile data may be determined by evaluation of rules. The rules may be based on a location of the recipient, including a time zone or other characteristics associated with the recipient.

### BACKGROUND

This disclosure relates generally to the field of electronic communication. More particularly, but not by way of limitation, it relates to avoiding electronic communications at no-contact times.

With the advent of mobile communication devices such as smartphones, people are more likely to have communications capability with them at all hours of the day or night, as well as the ability to communicate with recipients worldwide. However, that capability brings with it the possibility that a communication may be received at a socially unacceptable time, for example interrupting the recipient's sleep. There is currently no automated way to ensure that communications will not be sent or received at socially unacceptable times for the recipient. Although some systems allow users to designate themselves as being in a “do not disturb” status, which will block attempts to contact that user, those settings are inflexible and must be manually turned on and off by the user.

### SUMMARY

Apparatus and methods for controlling communications allow a recipient of electronic communications to be designated as in a no-contact state based on a profile data associated with the recipient. An attempt to send an electronic communication to the recipient when the recipient is in a no-contact state will result in the electronic communication not being transmitted at that time, although variants may allow queuing the electronic communication for later delivery. The no-contact state based on the profile data may be determined by evaluation of rules. The rules may be based on a location of the recipient, including a time zone or other characteristics associated with the recipient.

A method to control communications is disclosed. The method includes receiving a request, by an programmable device, to transmit an electronic communication at a first time; determining a recipient of the electronic communication;

reviewing profile data associated with the recipient; determining the electronic communication should not be transmitted to the recipient based on the act of reviewing the profile data; and generating a notification in response to determining the electronic communication should not be transmitted.

Another method of controlling communications is disclosed. The method includes receiving a communication by a programmable device associated with a recipient of the communication; reviewing a profile data associated with the recipient; determining based on the profile data whether the recipient is in a no-contact state; and preventing the presentation of the communication to the recipient if the recipient is in a no-contact state.

A system is disclosed. The system includes a first programmable device, associated with a first person; a second programmable device, associated with a second person; and an intermediary programmable device, communicatively coupled to the first programmable device and the second programmable device. The first programmable device includes computer code for restricting communications between the first programmable device and the second programmable device, responsive to an indication that the second person is in a no-contact state. The computer code includes computer code to access a profile data associated with the second person; computer code to review the profile data to determine whether the second person is in a no-contact state; and computer code to restrict transmittal of a communication from the first person to the second person on the second programmable device if the second person is in the no-contact state. The second programmable device includes computer code for creating the profile data associated with the second person, the profile data defining whether the second person is in a no-contact state; and computer code to restrict presentation of a communication from the first person to the second person on the second programmable device if the second person is in the no-contact state. The intermediary programmable device includes a first storage medium configured to store the profile data associated with the second person.

A computer readable storage medium is disclosed. Instructions are stored thereon that when executed cause a programmable device to perform actions comprising receiving a request, by an programmable device, to transmit an electronic communication; determining a recipient of the electronic communication; reviewing profile data associated with the recipient; determining whether the electronic communication should be transmitted to the recipient based on the act of reviewing the profile data.

A programmable device is disclosed. The programmable device includes a programmable control device; a storage device, coupled to the programmable control device; and software, stored on the storage device. The software includes computer code to receive a request to transmit an electronic communication; computer code to determine a recipient of the electronic communication; computer code to review profile data associated with the recipient; computer code to use the profile data to make a decision whether recipient is in a no-contact state, wherein the electronic communication should not be transmitted to the recipient if the recipient is in the no-contact state; and computer code to provide a notification to a user of the programmable device corresponding to the decision.

### BRIEF DESCRIPTION OF THE DRAWINGS

FIG. 1 is a block diagram that illustrates a user interface display indicating a recipient is in a no-contact state.

FIGS. 2A, 2B are block diagrams that illustrate variants of a user interface element that may appear when an attempt is made to communicate with a recipient in a no-contact state.

FIG. 3 is a block diagram that illustrates a user interface for instant messaging that indicates a proposed instant message recipient is in a no-contact state.

FIG. 4 is a block diagram that illustrates user interface for telephone calls that indicates a person to be called is in a no-contact state.

FIGS. 5A, 5B are flowcharts that illustrate techniques for determining whether to send or receive a communication based on a no-contact state.

FIG. 6 is a flowchart that illustrates a technique for reviewing communications that have been queued for recipients in a no-contact state.

FIG. 7 is a block diagram that illustrates a programmable device for sending or receiving communications to recipients who may be in a no-contact state.

FIG. 8 is a block diagram of a networked system for sending and receiving communications to recipients who may be in a no-contact state.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter.

For clarity of the following description, the term “instant message” should be understood as incorporating messages transmitted over a telephone network using Short Message Service messages, as well as real-time messages sent over the Internet by software generally referred to as instant message (IM) software, which may be standalone software or functionality provided by web browsers. The term “communication” encompasses all types of electronic communications between a sender and a recipient, including telephone calls, electronic mail (email) messages, and instant messages.

Some of the restrictions on receipt of communications provided by the techniques described herein may be based upon socially unacceptable times, such as times that might interrupt a recipient's sleep or other activities where interruptions may be undesirable. In other examples, the recipient's location may be used to prevent contact at certain locations, where audible notifications on a person's device might be annoying or embarrassing to the recipient, such as when the person is in a concert hall or a theater. In such an example, a recipient's device may determine its location and compare that with known no-contact locations to determine whether the recipient should be placed into no-contact status. Other types of restrictions may be provided, in which a recipient may not wish to be contacted for whatever reason. In general, these times are referred to herein as “no-contact times,” since they may encompass any time that a recipient may wish not to be contacted or interrupted by a communication.

By associating information about no-contact times for receiving communications with recipients, the techniques below can allow automatically avoiding the nuisance to the recipient of receiving communications at undesirable times, such as when the recipient is asleep or performing an activity where interruptions would be undesirable. These no-contact times may be individually defined or based upon rules that may be defined for groups or locations, such as rules based upon a time zone that may be applied based upon a recipient's location.

For example, a default rule might be to denote that a recipient should not receive communications during normal night-time hours for that region or time zone, specifying a start and end time for the no-contact period. Individuals may override default rules with either personal rules or specific time settings, for individual events or normal daily activities. For example, a default rule might denote 10:00 PM until 6:00 AM local time as a no-contact (sleeping) period, but a user with a different schedule may change that rule to specify 1:00 AM until noon local time as the no-contact period. Other user-defined rules may indicate that no communications are desired at any time on Christmas day, or that email may be received between 1:00 PM and 2:30 PM on Apr. 1, 2012, but phone calls and instant messages may not be received during that time. These rules and specific times are illustrative and by way of example only, and rules may specify any time or date period and any type of communication that is to be allowed or blocked during that period, including recurring time periods. Although illustrated herein as providing feedback to senders that the recipient is in a “do not disturb” state, some implementations may allow users to label the no-contact time with a more specific label, such as “sleeping” if desired.

Although described herein as defining no-contact times, variants may provide profile data that define acceptable contact times, and consider no-contact times as those times outside of the acceptable contact times.

Rules may be defined by both senders and recipients, allowing a sender to restrict communications to a recipient independently of any restrictions that may be set by or for the recipient. Thus, for example, a sender might choose not to allow phone calls to a recipient after 9:00 PM, even if the recipient has restricted calls only after midnight, or has not made any restrictions.

These rules may be maintained local to the sender, the recipient, an intermediary server, or any combination thereof. Any convenient or desired technique for storing the rules may be used, including storing the rules with other profile information for the recipient or storing the rules in a separate rules database.

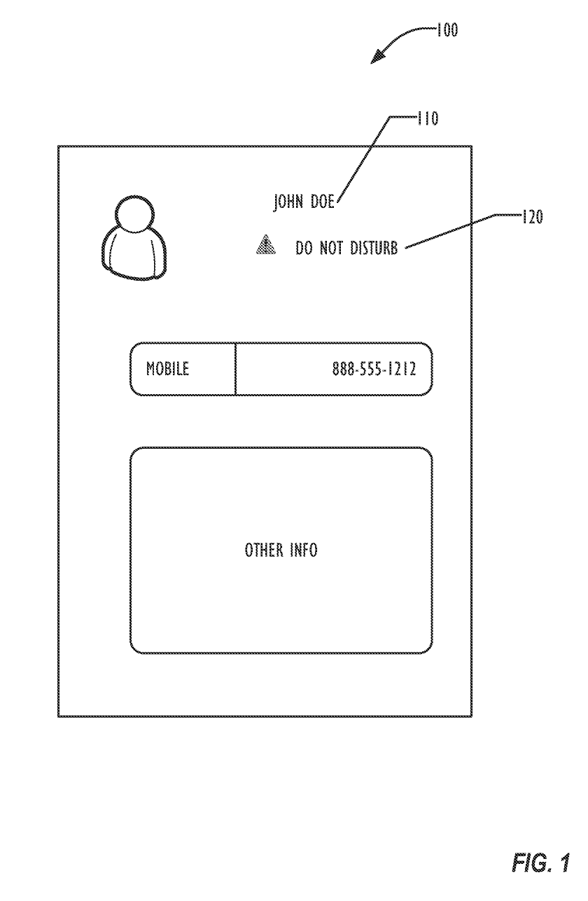

FIG. 1 is a block diagram illustrating a user interface 100 that provides information to a user on a recipient's status. In this example, user John Doe (110) has a profile or contact entry status indicator data 120 that indicates that John Doe is not to be contacted. As indicated above, the status 120 might be set by John Doe and the status communicated to those persons who have his contact information, either directly or via an intermediate server. Alternately, the status 120 might be set by the user who has a contact entry for John Doe, either by rule or manually. Such a visual indicator of John Doe's status may present a passive disincentive to send John Doe a communication, but as described below, software in the sender's programmable device may also take steps to honor the “no-contact” indicator 120, restricting the sender's attempts to communicate with John Doe via the programmable device.

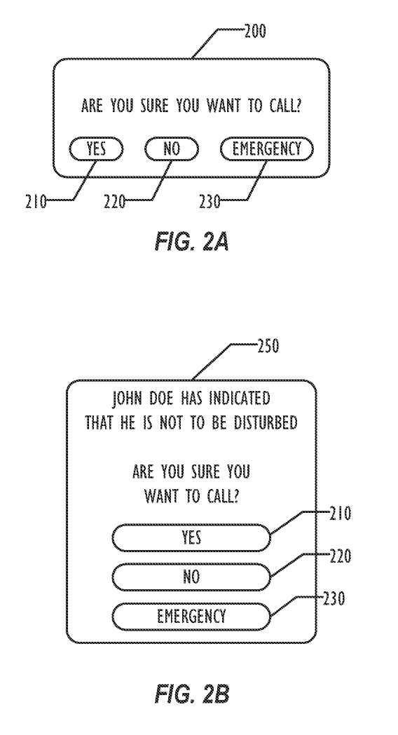

FIGS. 2A and 2B are two variants of a user interface that may restrict communications with a recipient such as John Doe (110). In FIG. 2A, an attempt to call with John Doe may produce an alert asking if the sender really wants to call John Doe that is automatically generated if John Doe's profile indicates a no-contact status. In this example, the user is given three choices: Yes (210), No (220), or Emergency (230). If the user selects “Yes” (210), then the indicator 120 exemplified in FIG. 1 may be sent, but if John Doe has configured the receiving device to refuse communications during the no-contact period, the communication may be refused or possibly queued instead of delivered. If the user selects “No” (220), then the sender is not allowed to send the communication. If the user selects “Emergency” (230), then the sender is allowed to send the communication, flagged as an emergency communication, and the emergency flagging may override John Doe's restrictions, allowing interrupting John Doe to get the emergency communication. FIG. 2A is a similar alert 250, but in addition to giving the Yes (210), No (220), and Emergency (230) choices, further indicates John Doe's no-contact status. The user interface illustrated in FIGS. 2A and 2B are illustrative and by way of example only, and other user interfaces may be used as desired. For example, instead of a Yes/No/Emergency interface as described above, a user interface allow the sender to send the message or place a call as soon as the receiver is available, taking advantage of a capability for queuing the communication described herein.

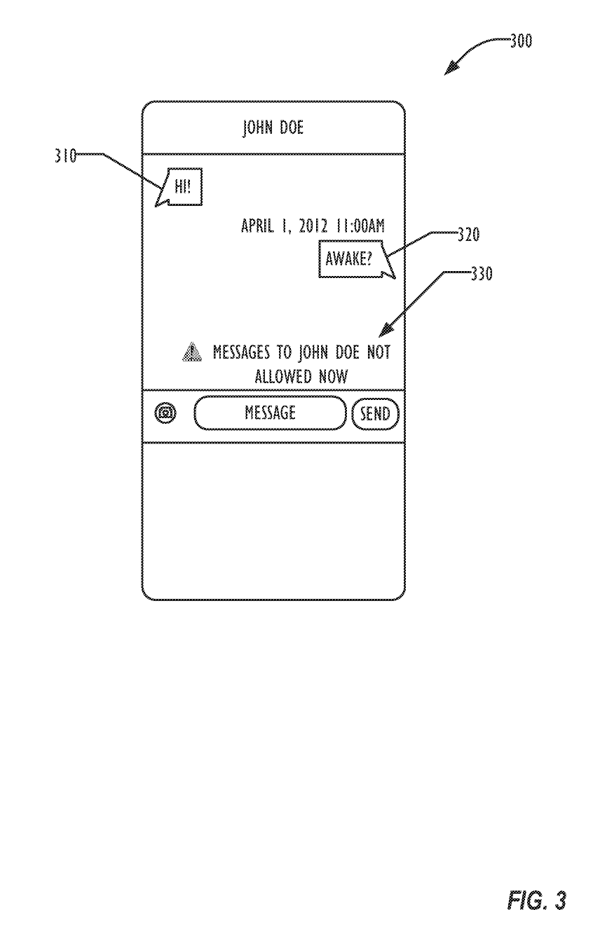

FIG. 3 is a block diagram for a text or instant messaging user interface 300, in this example showing an earlier message from John Doe of “Hi!” (310) arriving at 11:00 AM on Apr. 1, 2012. But when the user of the programmable device attempts to message back “Awake?” (320), John Doe's status has changed to a no-contact state and the message is blocked, giving the alert 330 that messages to John Doe are not allowed at that time.

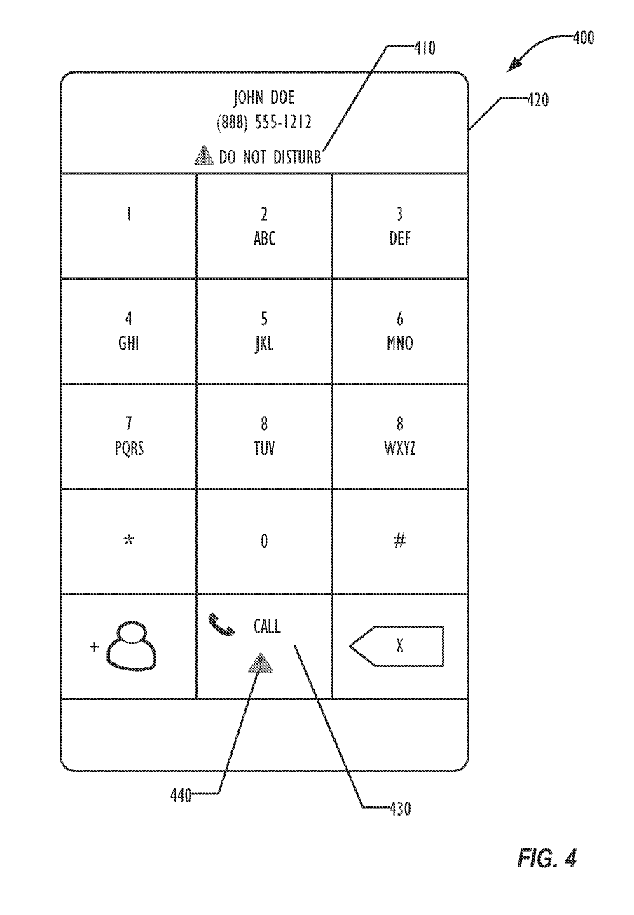

FIG. 4 is a block diagram of a smartphone keyboard interface 400 in which a user is attempting to call John Doe at the mobile phone number indicated in the contact entry illustrated in FIG. 1. Because that contact entry indicates that John Doe is sleeping, the interface 400 may warn the user that John Doe is in a no-contact state using indicator 410 in the name and number region 420 of the interface 400, as well as flagging the Call button 430 with a warning indicator 440. Some implementations may refuse to make the call in this situation; other implementations may give the warning, but make the call anyway, letting John Doe's phone, if capable, avoid the no-contact time interruption by simply automatically routing the call to a voicemail system without ringing the phone or taking some other pre-configured action to reject the call.

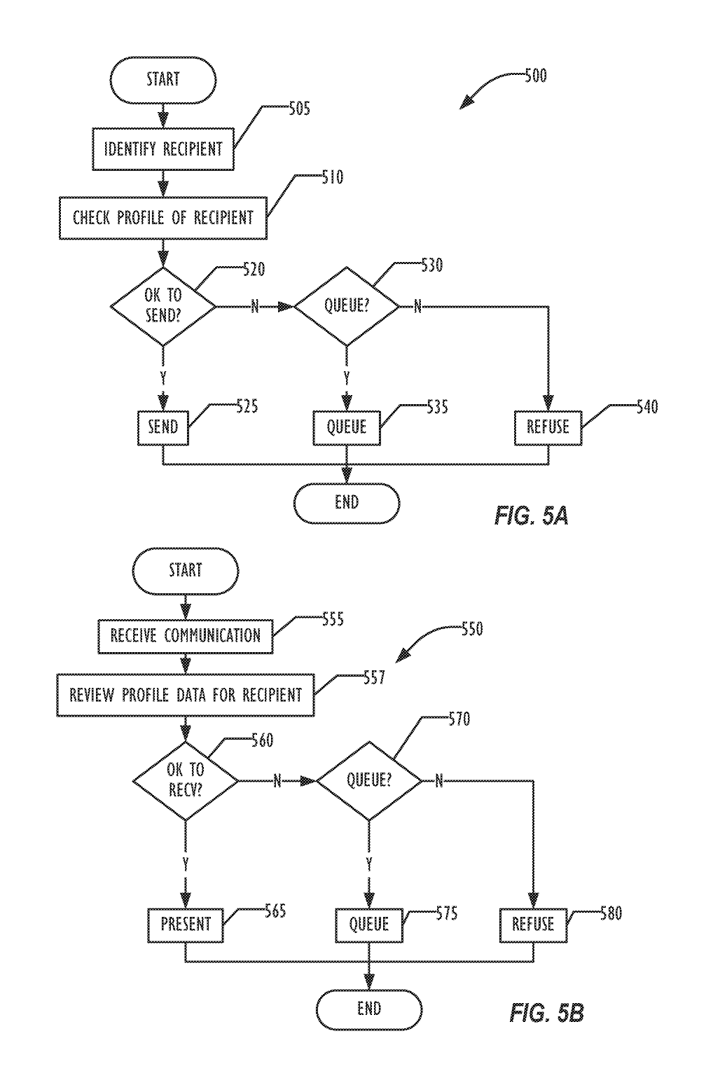

FIGS. 5A and 5B are flowcharts 500 and 550 illustrating a technique for restricting communication during no-contact times. In FIG. 5A, a programmable device of a user receiving a request to transmit a communication to a recipient identifies the recipient in block 505. The programmable device reviews profile data associated with that recipient in block 510 for indications that communications should be restricted. The profile data may be obtained locally from the programmable device, or may be accessed at a remote or non-local device via a communication network, including one or more mobile phone networks. The profile data may include any desired information associated with the recipient, including a current time data, a time zone, and a location of the recipient. Where the recipient profile data indicates a time zone different from a time zone associated with the sender, the recipient's and sender's current time may be adjusted to a common time zone. The review of the profile data may involve the evaluation of one or more rules. In block 520, if an indication is found and the particular communication technique (phone call, email, instant message, etc.) is not restricted at that time for the recipient, then the communication may be made or sent in block 525. Additional information associated with the recipient, including cultural information, may be used in the rules. For example, a Jewish recipient may choose not to receive communications on the Sabbath. In another example, a resident of Spain may choose rules that avoid communications during the traditional siesta period.

Unlike conventional “do not disturb” settings, which require a manual action by the person wishing not to be disturbed, both to start and stop “do not disturb” status, the profile data may indicate whether the recipient is in a no-contact state without any interaction with the recipient to initiate or terminate the no-contact state. For example, the profile data may define a no-contact time window, and the recipient will automatically be determined to be in the no-contact state if the time the message is sent (or received) is in the no-contact time window. The no-contact time window may exceed a single day in length, designating a period of one or more days if desired. The profile data may also designate one or more senders from whom the recipient does not wish to receive communications, so that a sender so designated would be informed that the recipient is in a no-contact state, while other senders would not have their communications to the recipient restricted.

Some programmable devices may allow for a sender to designate that an electronic communication is not to be delivered before a designated time in the future, instead of being sent immediately. In such a situation, the reviewing of profile data to determine the no-contact state of the recipient uses the designated sending time, rather than the current time at the sender when making any determination of whether the recipient is in a no-contact state.

If the recipient is in a no-contact state, some implementations may allow the communication to be prepared and queued for later delivery on the sender's programmable device or elsewhere. In such an implementation, a check is made in block 530 to determine whether the communication should be queued for later sending. If queuing is allowed, the communication may be queued in block 535, either on the sender's device or on an intermediary server. Otherwise, the communication may be refused in block 540. In some variants, the sender may be offered a dialog such as the ones illustrated in FIGS. 2A and 2B that allows the sender to override the no-contact state for emergency communications or whether the sender cannot determine whether the recipient is in a no-contact state. When queuing a communication, a designation of a time for the communication to be dequeued and transmitted to the recipient may be made.

If the recipient is in a no-contact state, a notification may be provided to the sender that the communication has been refused or delayed by queuing. In some variants, the sender may be offered a dialog such as the ones illustrated in FIGS. 2A and 2B that allows the sender to override the no-contact state for emergency communications or whether the sender cannot determine whether the recipient is in a no-contact state.

FIG. 5B is a flowchart 550 illustrating a similar technique, performed by a programmable device of a recipient. In block 555, a communication is received by the recipient's programmable device. In block 557, a profile data associated with the recipient is accessed. In block 560, if the communication is received at a time when the profile data indicates the recipient is not in a no-contact state, which may require the evaluation of one or more rules to determine, then the communication may be presented to the recipient in block 565. Presentation of a communication to the user may include displaying the communication on a screen or, in the case of a phone call, allowing the caller's voice to be heard on a speaker or through headphones connected to the device. Presentation may also include presenting a notification to the recipient, such as playing a ringtone, engaging a vibration feature, or displaying an alert on a display of the recipient's device as configured by the recipient.

If the communication arrives at a no-contact time and presentation of the communication to the recipient should be prevented, then in block 570 the programmable device may determine whether to queue the communication in block 575, or simply to refuse it in block 580. In the case of a phone call communication, refusal may also involve routing the phone call to a voicemail application or service. Where an emergency indication is transmitted with the communication, block 560 may honor the emergency indication and allow receipt of the communication, even if the communication arrives at a time that is configured as a no-contact time. For communications that are refused, various implementations may return a notification to the sender of the refused communication or simply refuse the communication without notification.

In techniques illustrated in FIGS. 5A and 5B, some of the processing may be performed local to the programmable device, and some remotely at an intermediary server. For example, queuing may be performed either by the sender's programmable device, holding the communication for transmission and delivery at a later time, or by an intermediary computer system such as a server remote or non-local to the sender's programmable device, transmitted from the sender's programmable device to the server, but queued and held on the server until an acceptable time for the recipient. Similarly, a recipient's programmable device may queue received communications, typically silently, then dequeue the communication upon the occurrence of a socially acceptable time period or upon request by the user.

In some implementations, some types of communications may be queued, while others may be refused, responsive to a configuration by the recipient or sender as appropriate. For example, phone calls do not lend themselves to queuing, but emails and instant messages may be queued if desired.

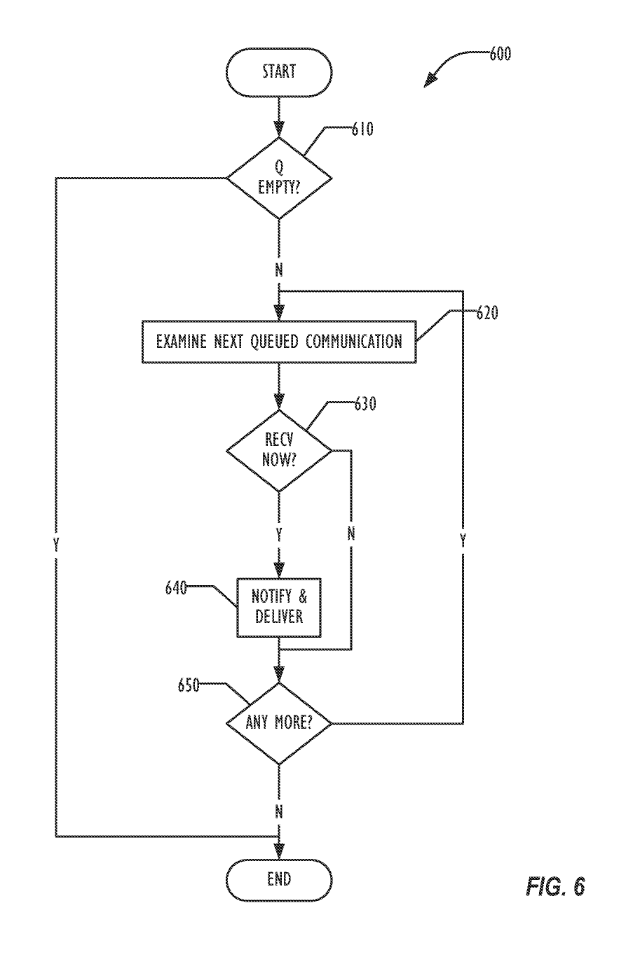

FIG. 6 is a flowchart illustrating a technique 600 for dequeuing queued communications. This technique may be performed by either a sender or a recipient either periodically or by request as desired. Periodically performing the technique 600 allows communications that have been queued during a no-contact time to be dequeued automatically. Alternately, software in the sender or recipient's programmable device may determine that a previously established no-contact time period has expired, triggering performance of technique 600. In addition, some implementations may allow a recipient to review queued communications at any time without dequeuing them.

In block 610, the queue of delayed communications is checked. Although as described herein as a single queue, multiple queues may be used, such as different queues for each type of communications. If the queue is empty, then there is nothing to dequeue and the technique terminates.

In blocks 620-650, each of the queued communications is checked. In block 630, if that communication can be received at the current time, then the communication is dequeued and in block 640 delivered to the recipient, possibly generating a notification of the delivery, such as playing a ringtone or displaying a message on a display of the programmable device. If the communication is still not deliverable, such as when the recipient is still in a no-contact state for communications of that type, then the communication is left on the queue, and after determining that any more queued communications are present in block 650, the sequence repeats in block 620 with the next queued communication.

Where communications are queued on an intermediary server, the dequeuing technique 600 may be performed on the intermediary server.

Implementation in an Programmable Device

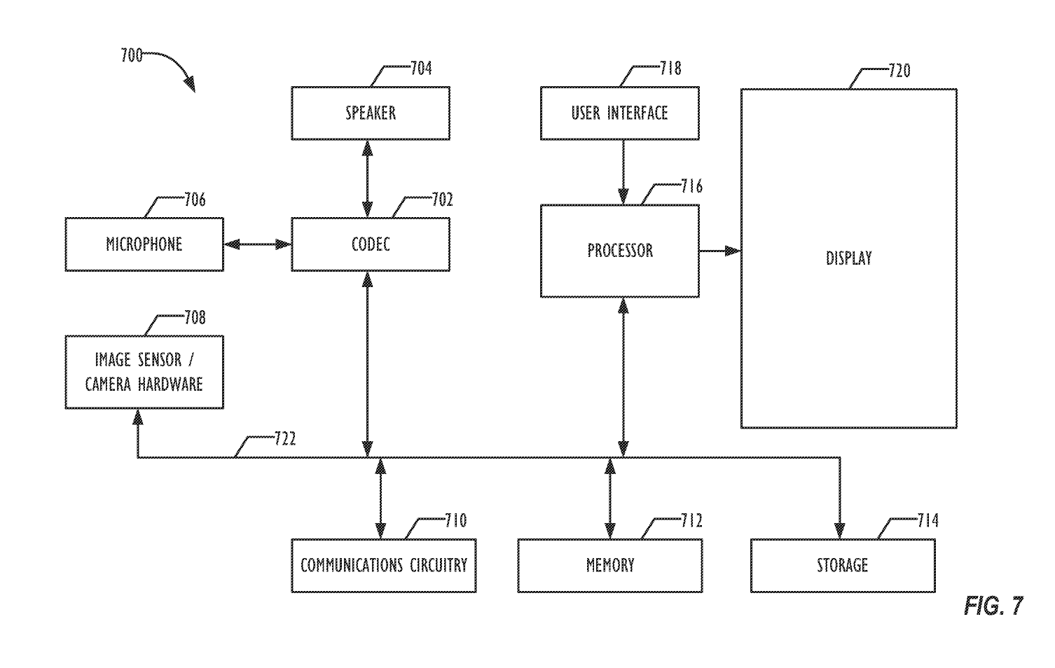

FIG. 7 is a simplified functional block diagram illustrating a programmable device FIG. 700 according to one embodiment that can implement the techniques described above. The programmable device FIG. 700 may include a processor FIG. 716, display FIG. 720, microphone FIG. 706, audio/video codecs FIG. 702, speaker FIG. 704, communications circuitry FIG. 710, an image sensor with associated camera hardware FIG. 708 for performing image capture, user interface FIG. 718, memory FIG. 712, storage device FIG. 714, and communications bus FIG. 722. Processor FIG. 716 may be any suitable programmable control device and may control the operation of many functions, such as the generation and/or processing of image data, as well as other functions performed by programmable device FIG. 700. Processor FIG. 716 may drive display FIG. 720 and may receive user inputs from the user interface FIG. 718. An embedded processor provides a versatile and robust programmable control device that may be utilized for carrying out the disclosed techniques.

Storage device FIG. 714 may store media (e.g., image and video files), software (e.g., for implementing various functions on device FIG. 700), preference information, device profile information, and any other suitable data. Storage device FIG. 714 may include one more storage mediums for tangibly recording image data and program instructions, including for example, a hard-drive, permanent memory such as ROM, semi-permanent memory such as RAM, or cache. Program instructions may comprise a software implementation encoded in any desired language (e.g., C or C++).

Memory FIG. 712 may include one or more different types of memory which may be used for performing device functions. For example, memory FIG. 712 may include cache, ROM, and/or RAM. Communications bus FIG. 722 may provide a data transfer path for transferring data to, from, or between at least storage device FIG. 714, memory FIG. 712, and processor FIG. 716. Although referred to as a bus, communications bus FIG. 722 is not limited to any specific data transfer technology. User interface FIG. 718 may allow a user to interact with the programmable device FIG. 700. For example, the user interface FIG. 718 can take a variety of forms, such as a button, keypad, dial, a click wheel, or a touch screen.

In one embodiment, the programmable device FIG. 700 may be a programmable device capable of processing and displaying media, such as image and video files. For example, the programmable device FIG. 700 may be a device such as such a mobile phone, personal data assistant (PDA), portable music player, monitor, television, laptop, desktop, and tablet computer, or other suitable personal device.

Implementation in a Network

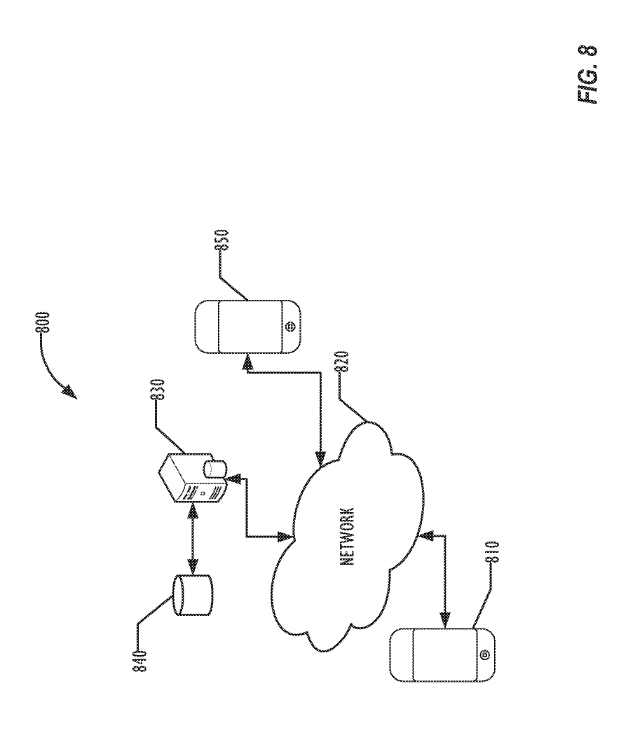

The techniques described above are typically implemented in a networked environment, such as is illustrated in FIG. 8. Sender programmable device 810 is coupled via a network 820 to recipient programmable device 850. The network may be any type of local or wide area network, including the Internet and telephone networks such as a mobile telephone network. Although only a single network 820 is illustrated for clarity, multiple connected networks may intermediate between sender device 810 and recipient device 850.

Intermediary server 830 is a programmable device that may provide services such as synchronizing recipient profile information between sender device 810 and recipient device 850, allowing indications of no-contact time periods for the recipient to be associated with a profile of the recipient on the sender device 810. In addition, the server 830 may provide a storage subsystem 840 for storing queued communications and other information useful and desirable for performing the techniques described above. Although described as a server, the intermediary server 830 may be any type of intermediary programmable device, typically at a location other than the location of the programmable device of the sender and the location of the programmable device of the recipient, to which the sender or receiver's programmable device can access.

Where the intermediary server 830 is accessed by the sender for storing communications to be queued for delivery to the recipient 850, the entries in the queue of stored communications may include a time for transmitting the communication to the recipient.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A method to control communications, comprising:
receiving a request, by a programmable device, to transmit an electronic communication at a first time;
determining a recipient of the electronic communication;
reviewing profile data associated with the recipient;
determining the electronic communication should not be transmitted to the recipient based on the act of reviewing the profile data; and
generating a notification in response to determining the electronic communication should not be transmitted.

2. The method of claim 1, wherein the act of receiving a request to transmit an electronic communication at a first time comprises receiving a request to transmit an electronic mail message at the first time.

3. The method of claim 1, wherein the act of receiving a request to transmit an electronic communication at a first time comprises receiving a request to transmit an instant message at a first time.

4. The method of claim 1, wherein the act of reviewing profile data associated with the recipient comprises obtaining access to the profile data via a communication network.

5. The method of claim 4, wherein the act of obtaining access to the profile data via a communication network comprises obtaining access to the profile data via one or more mobile phone networks.

6. The method of claim 1, wherein the act of reviewing profile data associated with the recipient comprises accessing time data associated with the recipient.

7. The method of claim 6, wherein the act of accessing time data associated with the recipient comprises:
determining a time zone of the recipient; and
determining a recipient time corresponding to the first time and based on the recipient time zone.

8. The method of claim 7, wherein the act of determining the electronic communication should not be transmitted to the recipient comprises determining the recipient time is outside an acceptable communication time specified in the profile data.

9. The method of claim 1, further comprising queuing the electronic communication for transmission at a time determined to be acceptable based on the profile data.

10. The method of claim 9, wherein the act of queuing the electronic communication comprises queuing the electronic communication at the programmable device.

11. The method of claim 9, wherein the act of queuing the electronic communication comprises queuing the electronic communication at a location other than the programmable device.

12. The method of claim 11, wherein the act of queuing the electronic communication at a location other than the programmable device, comprises:
obtaining access to a non-local computer system; and
storing the electronic communication at the non-local computer system.

13. The method of claim 12, wherein the act of obtaining access to a non-local computer system comprises obtaining access to a non-local computer system via a communication network.

14. The method of claim 13, wherein the act of obtaining access to a non-local computer system via a communication network comprises obtaining access to a non-local computer system via a wide area network.

15. The method of claim 12, wherein the act of storing the electronic communication at the non-local computer system, further comprises designating a time for the electronic communication to be transmitted to the designation.

16. The method of claim 1, wherein the act of determining the electronic communication should not be transmitted to the recipient comprises:
determining the profile data designates a no-contact time window; and
determining the first time falls within the no-contact time window.

17. The method of claim 16, wherein the no-contact time window comprises one or more days.

18. The method of claim 1, wherein the act of determining the electronic communication should not be transmitted to the recipient comprises:
determining the profile data designates one or more persons from which electronic communications should be rejected; and
determining the programmable device is associated with at least one of the designated one or more persons.

19. A method of controlling communications, comprising:
receiving a communication by a programmable device associated with a recipient of the communication;
reviewing a profile data associated with the recipient;
determining based on the profile data whether the recipient is in a no-contact state; and
preventing presentation of the communication to the recipient if the recipient is in a no-contact state.

20. The method of claim 19, wherein the act of preventing presentation of the communication comprises:
queuing the communication for later presentation to the recipient.

21. The method of claim 20, wherein the act of queuing the communication is performed remotely to the programmable device associated with the recipient.

22. The method of claim 20, further comprising:
dequeuing the communication; and
presenting the communication to the recipient at a time when the recipient is not in a no-contact state.

23. The method of claim 20, further comprising:
allowing the recipient to review queued communications.

24. The method of claim 19, further comprising:
creating a rule defining a time period during which the recipient is in a no-contact state.

25. The method of claim 24, wherein the act of creating a rule comprises:
creating a rule associated with a location of the recipient, wherein the rule defines a time period at the location during which the recipient is in a no-contact state.

26. The method of claim 24, further comprising:
storing the rule in a rules database.

27. The method of claim 19, wherein the act of receiving a communication comprises:
receiving a phone call on the programmable device associated with the recipient.

28. The method of claim 19, wherein the act of receiving a communication comprises:
receiving an electronic mail message on the programmable device associated with the recipient.

29. The method of claim 19, further comprising:
creating a rule defining a location, wherein the recipient is in a no-contact state if the recipient is in a no-contact state.

30. A system, comprising:
a first programmable device, associated with a first person;
a second programmable device, associated with a second person; and
an intermediary programmable device, communicatively coupled to the first programmable device and the second programmable device,
wherein the first programmable device comprises:
computer code for restricting communications between the first programmable device and the second programmable device, responsive to an indication that the second person is in a no-contact state, comprising:
computer code to access a profile data associated with the second person;
computer code to review the profile data to determine whether the second person is in a no-contact state; and
computer code to restrict transmittal of a communication from the first person to the second person on the second programmable device if the second person is in the no-contact state,
wherein the second programmable device comprises:
computer code for creating the profile data associated with the second person, the profile data defining whether the second person is in a no-contact state; and
computer code to restrict presentation of a communication from the first person to the second person on the second programmable device if the second person is in the no-contact state, and
wherein the intermediary programmable device comprises:
a first storage medium configured to store the profile data associated with the second person.

31. The system of claim 30, wherein the profile data defines whether the second person is in a no-contact state without an interaction with the second person.

32. The system of claim 30,
wherein the intermediary programmable device further comprises:
a second storage medium configured to store the communication from the first person to the second person; and
computer code to transmit the communication from the second storage medium stored on the second storage medium to the second programmable device if the second person is not in the no-contact state, and
wherein computer code to restrict the transmittal of a communication from the first person to the second person comprises:
computer code to queue the communication on the second storage medium if the second person is in the no-contact state.

33. The system of claim 30,
wherein the intermediary programmable device further comprises:
a second storage medium configured to store the communication from the first person to the second person; and
computer code to transmit the communication from the second storage medium stored on the second storage medium to the second programmable device if the second person is not in the no-contact state, and
wherein computer code to restrict presentation of the communication comprises:
computer code to queue the communication on the second storage medium if the second person is in the no-contact state.

34. The system of claim 30, wherein the computer code to review the profile data to determine whether the second person is in a no-contact state comprises:
computer code to evaluate a rule corresponding to a time zone associated with the second person.

35. The system of claim 30, wherein the computer code to review the profile data to determine whether the second person is in a no-contact state comprises:
computer code to evaluate a rule corresponding to a location associated with the second person.

36. The system of claim 30, wherein the communication is an electronic mail message.

37. The system of claim 30, wherein the communication is an instant message.

38. The system of claim 30, wherein the computer code to review the profile data to determine whether the second person is in a no-contact state comprises:
computer code to determine whether a time local to the first person is outside an acceptable communication time specified by the profile data.

39. A computer readable storage medium, on which are stored instructions that when executed cause a programmable device to perform actions comprising:
receiving a request, by a programmable device, to transmit an electronic communication;
determining a recipient of the electronic communication;
reviewing profile data associated with the recipient; and
determining whether the electronic communication should be transmitted to the recipient based on the act of reviewing the profile data.

40. The computer readable storage medium of claim 39, wherein the instructions stored thereon further comprises instructions to cause the programmable device to perform actions comprising:
generating a notification if the electronic communication should not be transmitted to the recipient based on the act of reviewing the profile data.

41. The computer readable storage medium of claim 39, wherein the instructions to cause the programmable device to perform the action of reviewing profile data associated with the recipient comprise instructions to cause the programmable device to perform actions comprising:
requesting access to a profile data associated with the recipient stored by another programmable device.

42. The computer readable storage medium of claim 39, wherein the actions further comprise:
queuing the electronic communication if the electronic communication should not be transmitted to the recipient based on the act of reviewing the profile data.

43. A programmable device, comprising:
a programmable control device;
a storage device, coupled to the programmable control device; and
software, stored on the storage device, comprising:
computer code to receive a request to transmit an electronic communication;
computer code to determine a recipient of the electronic communication;
computer code to review profile data associated with the recipient;
computer code to use the profile data to make a decision whether recipient is in a no-contact state, wherein the electronic communication should not be transmitted to the recipient if the recipient is in the no-contact state; and
computer code to provide a notification to a user of the programmable device corresponding to the decision.

44. The programmable device of claim 43, wherein the software further comprises:
computer code to allow the user of the programmable device to override the decision whether the electronic communication should be transmitted to the recipient.

45. The programmable device of claim 43, wherein the software further comprises:
computer code to allow the user to designate the electronic communication as an emergency electronic communication that should be transmitted to the recipient even if the recipient is in the no-contact state.

46. The programmable device of claim 43, wherein the profile data comprises:
a rule defining a no-contact time period.

47. The programmable device of claim 46, wherein the rule defines a no-contact period associated with a time zone.

48. The programmable device of claim 43, wherein the profile data comprises:
a rule defining a no-contact location.

49. The programmable device of claim 43, wherein the software further comprises:
computer code to queue the electronic communication for later transmittal responsive to the decision.
